(19) United States
(12) Patent Application Publication
(10) Pub. No.: US 2018/0161779 A1
(43) Pub. Date: Jun. 14, 2018

(54) Discharge System for a Waste Processing Machine and Method Thereof

(71) Applicant: Smoracy, LLC, Remus, MI (US)

(72) Inventors: Kyle Douglas KIMBELL, Vestaburg, MI (US); Jack Lee COOPER, Riverdale, MI (US)

(73) Assignee: Smoracy, LLC, Remus, MI (US)

(21) Appl. No.: 15/577,832

(22) PCT Filed: May 31, 2016
(86) PCT No.: PCT/US16/35066

§ 371 Date: Nov. 29, 2017

Related U.S. Application Data
(60) Provisional application No. 62/168,674, filed on May 29, 2015.

(51) Int. Cl. B02C 18/22; B02C 21/02

(52) U.S. Cl. CPC B02C 18/2216; B02C 18/2241; B02C 21/02

(57) ABSTRACT

A waste processing system for processing wood and brush products, or other material includes an infeed system, a cutting system, and a discharge system, wherein the discharge system includes a primary-stage discharge assembly and at least one selectable secondary-stage discharge assembly.

### BACKGROUND OF THE INVENTION

The present invention relates generally to waste processing machines, and more specifically to waste processing machines for processing wood and brush material such as logs, branches, brush, and the like.

A variety of systems have been developed to recycle, reduce, or in other respects process waste products. Such systems may include for example, machines which recycle, reduce, and otherwise process wood and/or brush products. Included therein are systems that chip, cut, grind, shred, and reduce these waste products and include, generally speaking, chippers (whether disk and drum types), grinders (whether disk, drum, tub, and horizontal types), shredders, hammer mills, hogs, forestry mowers and the like.

These waste processing systems typically include an infeed system, a feed system, and a reducing, grinding, and cutting system, wherein the infeed system is used for directing the reducible material to the feed system moving the material into contact with the reducing system; the reducing system being used for reducing the in-fed material. These waste processing systems also typically include a discharge system for removing and directing the reduced material.

The infeed assembly may comprise, for example, a conveyer infeed system, which further may be adapted for assisting and controlling the feed rate of the waste products. The feed system may comprise, for example only, a feed wheel assembly comprising one or more feed-wheels, which further may be adapted for assisting and controlling the feed rate of waste products. The cutting assembly may comprise, for example only, a drum assembly further comprising reducing members, and the discharge system or assembly may comprise, for example only, a conveyer discharge system.

These waste processing systems may comprise industrial and conveyer fed waste processing systems which are capable of quickly reducing bulky (e.g., large sized) wood products, as well as doing so in high volume applications. For example, these conveyor-fed systems may be used to reduce whole trees, stumps, and trunks, as well as branches, brush, and other bulk wood products in land clearing and recycle operations. Such exemplary waste products may also include wet leaves; landscape waste; pallets; railroad ties; telephone poles; construction waste; and sawmill, logging, chip mill and paper mill waste. Yet further, these systems may be used to process such materials in order to produce or generate desired end-products including, for example, wood chips and mulch for use in horticultural applications, pressed wood products, biofuel applications, and wood fuel applications. Still further, these conveyor-fed systems may be used to reduce and recycle grindable nonorganic material including asphalt products (e.g., shingles), rubber products (e.g., tires), and plastic materials (e.g. consumer and industrial plastic processing including recycling).

Improvements are desired in the methods and systems used for discharging the reduced waste material. Therefore, there is a need in the art to provide improved waste processing systems and improved waste processing discharging systems and methods. For example, benefits may be found in (1) improving the reduction and discharge operation; (2) increasing the discharge output and efficiency; (3) allowing for multiple independently operable discharge systems; and (4) providing for an additional discharge system. These benefits may further result in (1) increasing productivity and yield; (2) reducing and preventing undesired discharge; (3) increasing the volume of material which is able to be processed concurrently or consecutively, and (4) increasing the output rate of material discharged via the discharge system. Waste processing systems and methods according to the present disclosure may thus provide increased efficiency; reduced maintenance and downtime, and reduced operation and maintenance costs.

### SUMMARY OF THE PRESENT INVENTION

The aforementioned drawbacks and disadvantages of these former waste processing devices, systems, and methods have been identified and solutions are set forth herein.

A waste processing system for reducing material includes a frame comprising at least one pair of wheels, a material reducing system operatively supported on the frame, a primary-stage discharge system disposed adjacent the material reducing system to expect processed material when the system is in a first mode; and a secondary-stage discharge system disposed adjacent the primary-stage discharge system to expel processed material when the system is in a second mode, wherein the primary-stage discharge system operates independently from the secondary-stage discharge system when the waste processing system is in the first mode, and wherein the secondary-stage discharge system is positionable to act cooperatively with the primary-stage discharge system (802) when the waste processing system is in the second mode.

Also disclosed is a method of operating a waste processing system having a material reducing system, a primary-stage conveyor discharge system, and a first and a second secondary-stage discharge system, the method including the steps of selecting one of the first and the second secondary-stage discharge systems for operation; moving the selected one of the first and the second secondary-stage discharge systems from a respective storage position to a respective in-use position; powering the selected one of the first and the second secondary-stage discharge systems in conjunction with the primary-stage discharge system; and expelling waste material from the waste processing machine through the primary-stage discharge system and the selected one of the first and the second secondary-stage discharge systems.

Further disclosed is an alternative method of operating a waste processing system having a material reducing system, a primary-stage discharge system, and a secondary-stage discharge system, the method including the steps of selecting one of a first mode of operation wherein the waste processing system expels processed material via the primary-stage discharge system and a second mode of operation wherein the waste processing system expels processed material via the primary-stage discharge system in conjunction with the secondary-stage discharge system; selectively moving the secondary-stage discharge system from an in-use position to a storage position for operation in the first mode and moving the secondary-stage discharge system from the storage position to the in-use position for operation in the second mode; selectively powering the primary-stage discharge system for operation in the first mode and powering the primary-stage discharge system and the secondary-stage discharge system for operation in the second mode; and selectively expelling material from the waste processing system through the primary-stage discharge system for operation in the first mode and expelling material from the waste processing system through the primary-stage discharge system and the secondary-stage discharge system for operation in the second mode.

Other objects, advantages, and features of the invention will become apparent upon consideration of the following detailed description and drawings. As such, the above brief descriptions set forth, rather broadly, features of the present disclosure so that the detailed descriptions that follow may be better understood and so that the contributions to the art may be better appreciated. There are, of course, additional features that will be described hereinafter which will form the subject matter of the claims.

In this respect, before explaining the disclosure in detail, it is to be understood the disclosure is not limited in its application to the details of the construction and the arrangements set forth in the following description or illustrated in the drawings. A waste processing system according to the present disclosure is capable of other embodiments and of being practiced and carried out in various ways. Also, it is to be understood the phraseology and terminology employed herein are for description and not limitation. Where specific dimensional and material specifications have been included or omitted from the specification or the claims, or both, it is to be understood that the same are not to be incorporated into he claims.

As such, those skilled in the art will appreciate that the conception upon which this disclosure is based may readily be used as a basis for designing other structures, methods, and systems, for carrying out the several purposes of the present disclosure. It is important therefore that the claims are regarded as including such equivalent constructions, as far as they do not depart from the spirit and scope of the present disclosure.

Furthermore, the purpose of the Abstract is to enable the United states Patent and Trademark Office, the public generally, and especially the scientist, engineers, and practitioners in the art who are not familiar with the patent or legal terms of phraseology, to learn quickly, from a cursory inspection, the natures of the technical disclosure of the application. Accordingly, the Abstract is intended to define neither the invention nor the application, which is only measured by the claims, nor is it intended to define neither the application nor the invention, which is only measured by the claims, nor is it intended to be limiting as to the scope of the invention in any manner.

These and other objects, along with the various features and structures that characterize the disclosure, are pointed out with particularity in the claims annexed to and forming a part of this disclosure. For a better understanding of the waste processing system of the present disclosure, its advantages, and the specific traits attained by its use, reference should be made to the accompanying drawings and other descriptive matter in which there are illustrated and described the embodiments of the disclosure.

As such, while embodiments of the waste processing system are herein illustrated and described, it is to be appreciated that various changes, rearrangements, and modifications may be made therein without departing from the scope of the invention as defined by the claims.

### BRIEF DESCRIPTION OF THE DRAWINGS

As a complement to the description and for better understanding of the specification presented herein, 17 pages of drawings are disclosed with an informative, but not limiting, intention.

FIG. 1 is a perspective view of a prior art waste processing machine.

FIG. 2 is a side view of another prior art waste processing machine.

FIG. 3 is a side view of a waste processing system according to the present disclosure.

FIG. 3A is an enlarged partial side view the waste processing system of FIG. 3, including a discharge system.

FIG. 4 is a side view of a waste processing system according to the present disclosure.

FIG. 4A is an enlarged partial side view of the waste processing system of FIG. 4, including the discharge system.

FIG. 4B is a perspective view of the waste processing system of FIG. 4.

FIG. 4C is another perspective view of the waste processing system of FIG. 4.

FIG. 5 is a side view of a waste processing system according to the present disclosure.

FIG. 5A is an enlarged partial side view of the waste processing system of FIG. 5, including the discharge system.

FIG. 6 is a side view of the waste processing system of FIG. 5 in a first configuration.

FIG. 6A is an enlarged partial side view of the waste processing system of FIG. 6, including the discharge system.

FIG. 6B is a perspective view of the waste processing system of FIG. 6.

FIG. 6C is another perspective view of the waste processing system of FIG. 6.

FIG. 7 is a side view a waste processing system according to the present disclosure, in a first configuration.

FIG. 8 is a side view of the waste processing system of FIG. 7, in a second configuration.

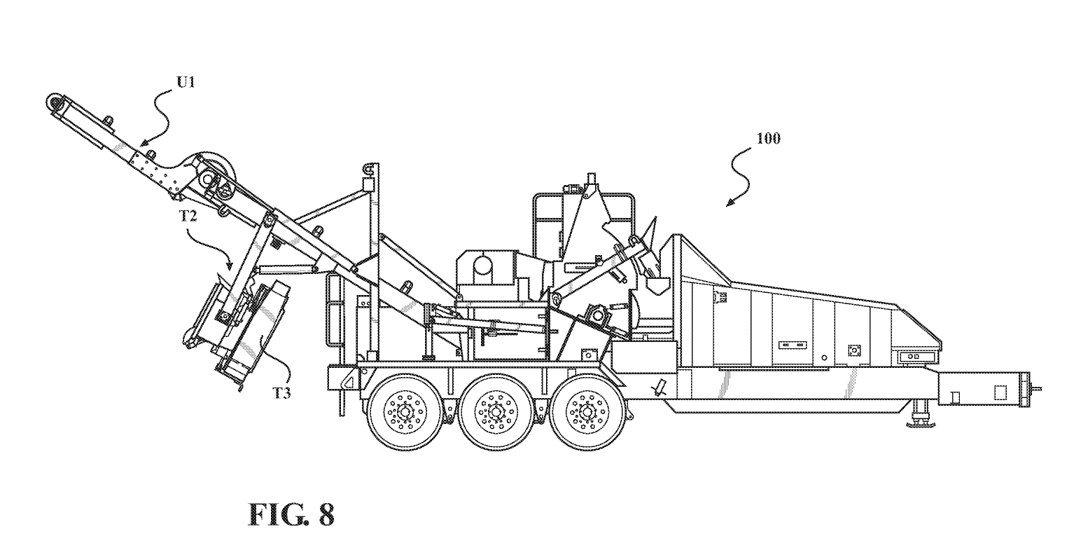

FIG. 9 is a side view of the waste processing system of FIG. 7, in a third configuration.

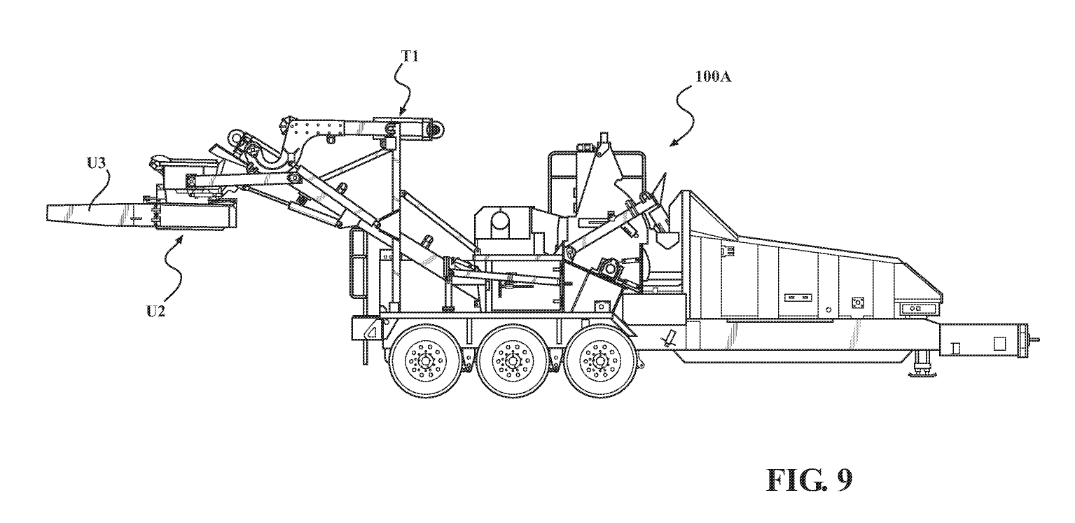

### DETAILED DESCRIPTION OF THE PREFERRED EMBODIMENT

Provided herein is a full and complete disclosure sufficient to enable one having ordinary skill in the art to practice the disclosure without undue experimentation, and a best mode of practicing the disclosure as presently contemplated by the inventor. This disclosure is not intended to limit the invention to the specific constructions, illustrations, dimensional characteristics, relationships, and/or operations as described in the specification and illustrated in the drawings. Various modifications, alternative constructions and embodiments, changes, and equivalents will readily occur to those skilled in the art. Such changes may involve, for example only, alternative materials, components, structural arrangements, sizes, shapes, forms, functions, methods, steps, operational features, steps or the like.

Accordingly, it is also to be understood that the specific embodiments, devices and/or processes described herein and illustrated in the attached drawings are exemplary embodiments of the inventive concepts which are defined in the appended claims. Hence, specific characteristics, dimensions, steps, and other physical or procedural characteristics relating to the disclosed embodiments are not to bee considered as limiting, unless the claims expressly state otherwise. Consequently, the proper scope of the present invention should be determined only by the broadest interpretation of the appended claims so as to encompass all such modifications as well as all relationships equivalent to those illustrated in the drawings and described in the specification.

With respect to the accompanying drawings, the same referenced numerals may be used throughout the drawings to refer to the same or like parts. Further, like features between the various embodiments may utilize similar numerical designations. Where appropriate, the various similar features may have been further differentiated by an alphanumeric designation.

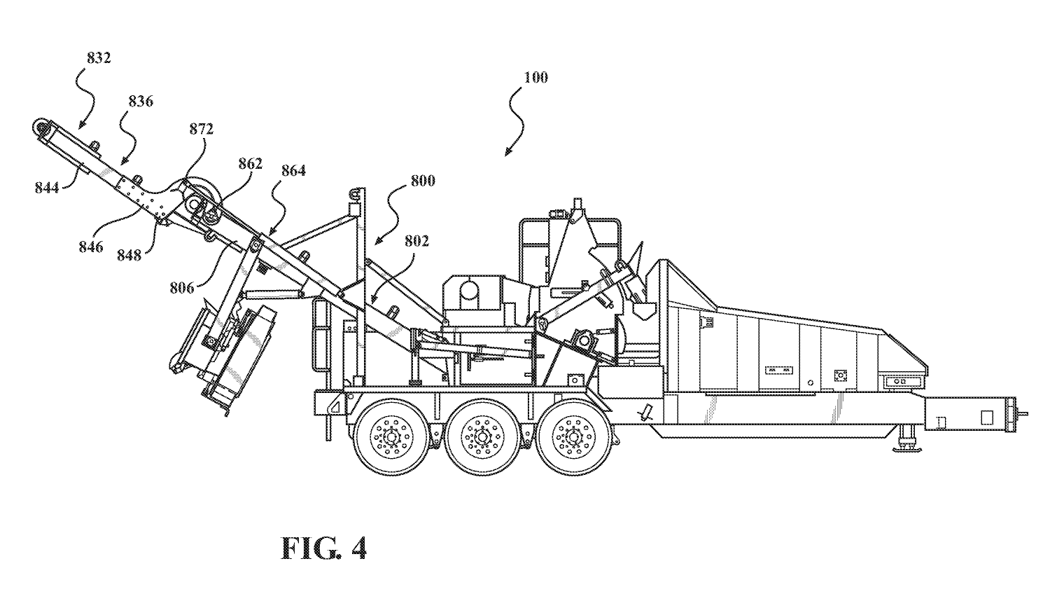

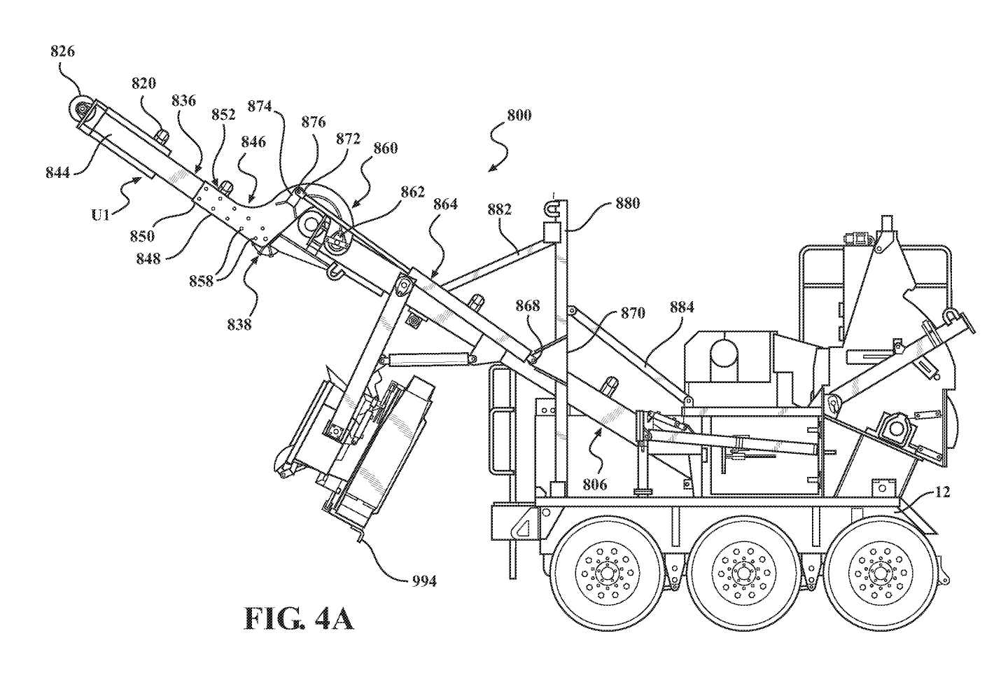

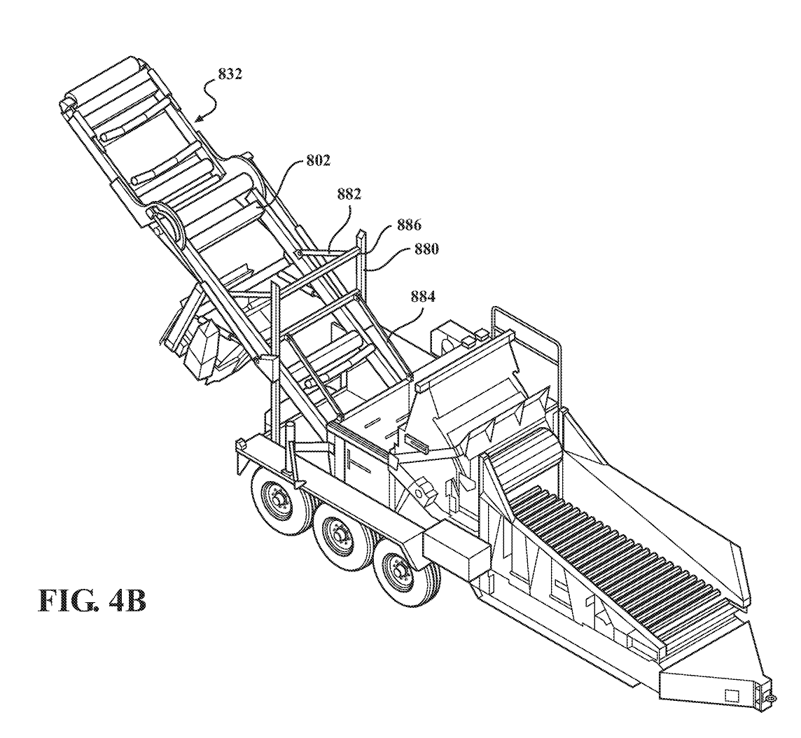

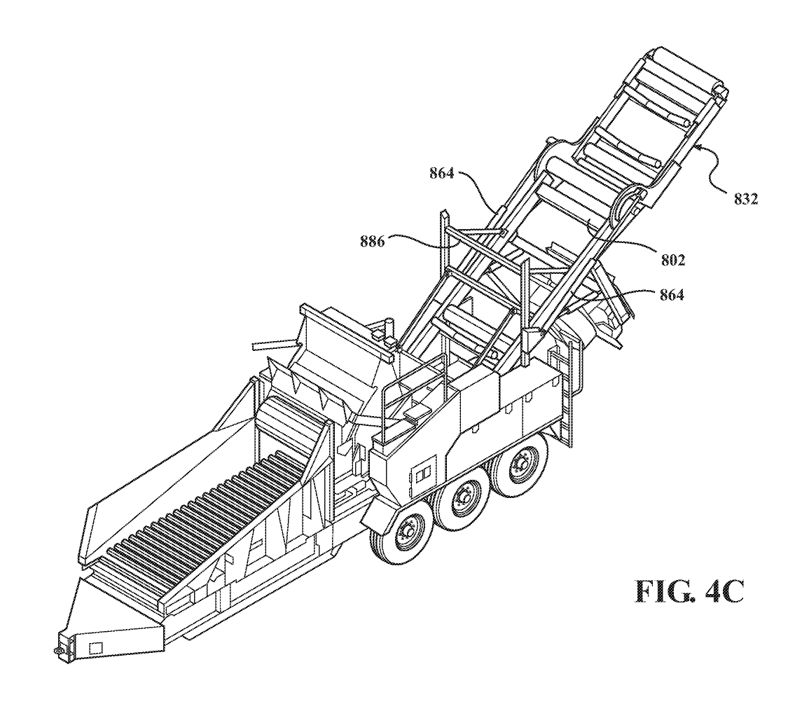

Accordingly, reference will now be made in detail to the various embodiments by way of this specification which includes the adjoining claims, as well as the drawings attached hereto. For purposes of description and as used herein: the terms “upper,” “lower,” “right,” “left,” “rear,” “front,” “vertical,” “horizontal,” and derivatives thereof shall relate to orientation depicted in FIG. 4B. However, it is to be understood that the invention may assume various alternative orientations, except where expressly specified to the contrary. As used herein, the terms “comprising,” “having,” “including,” and “containing” are meant to be used and defined in the broad, general, and ordinary sense and are to be construed as open-ended terms (i.e., meaning “including, but not limited to,” and “having at least the following elements . . . ”) unless otherwise noted. The terms “a,” “an,” “the,” and the like are meant to be used and defined in the broad, general, and ordinary sense and include both the singular and the plural. The terms “about”, “substantially”, “sufficient”, “generally” and other like words and phrases are relative terms and are meant to be used, defined as, and provide a broader range of coverage as compared with those words and phrases not so modified, as reasonably supported by this specification, and as a person of ordinary skill in the art would interpret same in light of the specification;

The use of examples and exemplary language (e.g., “for example,” “such as,” and “advantageous”) are intended for descriptive purposes only and not for limitation as to the scope of the invention or claims. Likewise, the expressions “in one embodiment,” “preferred embodiment,” “particular embodiment,” “advantageous embodiment,” or other like designations are also intended for descriptive purposes only and not for limitation as to the scope of the invention or claims. Furthermore, such designations are not intended to separate or isolate the described features of a particular embodiment from other embodiments. Features described with respect to one embodiment may be combined, adapted or modified for an alternative embodiment, as will be understood by one having ordinary skill in the art having ready and understood the present disclosure.

As used herein, the term waste processing system or machine is meant to be used and defined in its broad, general, and ordinary sense, in regard to systems that recycle, reduce, or otherwise process waste products. Included therein are machines that chip, cut, grind, shred, or otherwise reduce waste products. This includes wood chippers, grinders, shredders, hammer mills, hogs, forestry mowers and the like. Of course, this is not meant to be limiting in any manner and these systems may take on numerous configurations, and may be used for numerous purposes as is generally known within the art. Further, while the term ‘waste” has become associated with and is commonly used when naming and referring to these systems, such systems may be used to process any reducible material and the terminology is not meant to be limited to “waste” products per se. Such systems may process material other than scrap or discarded material.

Therefore, the term “waste product” is meant to be used and defined in its broad, general, and ordinary sense, and the terminology is meant to include, but not be limited to, wood and brush products. However, waste products may broadly include any reducible material including non-wood organic material, nonorganic material, grindable trash, other refuse, or other grindable, recyclable material. Yet further, while such material may comprise a waste product, either initially or post-processed, the definition is meant to include products which are processed to create a desired end product. For example, trees that are useful for other purposes such as dimensional lumber may nevertheless be processed into wood chips and mulch. Likewise, plastics which may be useful for other purposes may nevertheless be processed into plastic chips for manufacturing, molding, or other operations.

As used herein, the terms “wood” and “brush products” are meant to be used and defined in their broad, general, and ordinary sense, and the terminology is meant to include trees, logs, brush, trunks, stumps, stems, branches, leaves, or the like, or anything else that could otherwise be recycled, reduced, or otherwise processed. These terms further relate to non-naturally occurring wood products such as lumber, pallets, or other products that could otherwise be recycled, reduced, or otherwise processed, and also relates to non-wood organic material.

The preceding terminology is used to introduce and/or describe a particular implementation, application, and/or method of carrying out the present disclosure. Any particular limitation associated with this terminology is not to be included within the limitations of the claims unless so stated.

Generally, while waste processing machines, such as wood chippers are commonly known and regularly utilized to reduce branches, trees, and other bulk wood products into smaller wood chips, the productivity of these systems are dependent upon numerous factors, including the efficiencies of the infeed, feed, reducing, and discharge systems. Consequently, systems and methods which increase the productivity, efficiencies, and operability of waste processing machines are desired. Further, systems and methods which decrease downtime and maintenance, reduce the costs associated with the maintenance, operation, and repair, and which increase the longevity and uptime of such waste processing machines are desired.

Accordingly, there is a need in the art to provide desired improvements in the discharge systems which provide, multiple, selectable, independent discharge systems and methods. Moreover, there is a need in the art to provide desired improvements to improve the feeding, reduction, and discharge operations; increase the productivity, utilization and yield; reduce and prevent undesired discharge; increase the volume of material which is able to be processed, as well as the output of the material discharged via the discharge system; increase the efficiency of such machines; increase the control of and over these waste processing machines; and reduce maintenance and downtime, and the costs associated therewith. Therefore, systems and methods which solve the aforementioned disadvantages, which can effectuate such improvements, and having the aforementioned advantages are desired and disclosed herein.

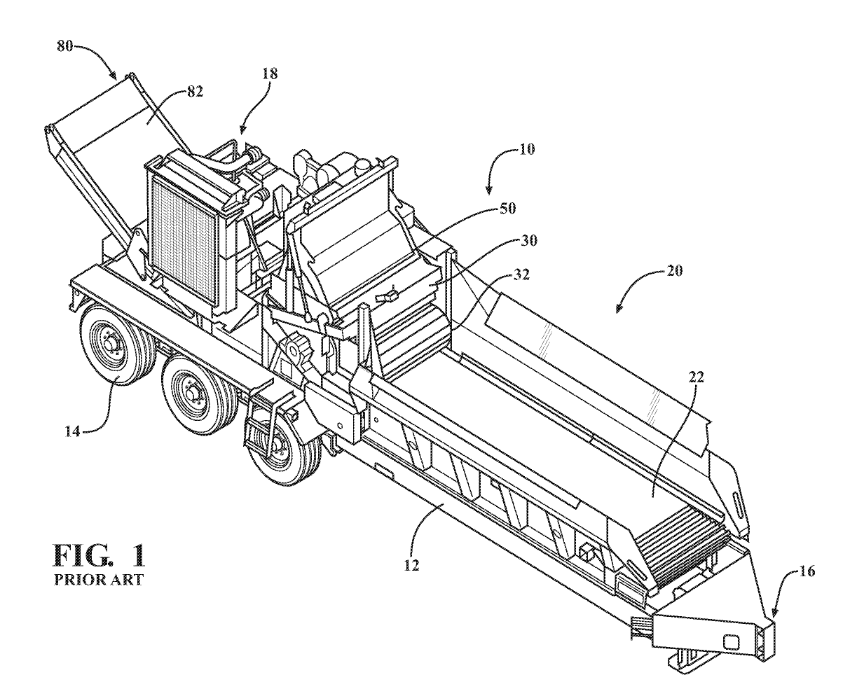

Referring now to the drawings and in particular to FIG. 1, a prior art waste processing system comprises a waste processing machine, shown generally at 10. The waste processing machine 10 includes a frame 12 supported by wheels 14, and a trailer hitch 16. This basic structure allows the waste processing machine 10 to be towed by a vehicle (not shown). The waste processing machine 12 further includes a power source 18 supported on the frame 12. Further supported on the frame 12, the waste processing machine 10 includes an infeed assembly 20, which includes an infeed conveyor 22 to allow wood or other material to enter the waste processing machine. Adjacent to the infeed assembly 20, the waste processing machine 10 has a feed system 30 to feed the wood or other material from the infeed assembly 20 to a material reducing system 50. The feed system 30 includes a feed wheel assembly, and typically includes at least one feed wheel 32. The material reducing system 50 is included in the waste processing machine 10 to process the wood or other material and typically includes a cutting assembly. Finally, the waste processing machine 10 includes a discharge assembly 80, including a discharge conveyor 82.

The power source 18 typically comprises an internal combustion engine and provides rotational energy to the feed wheel(s) 32 of the feed system 30 and to the cutting assembly (not shown) of the material reducing system 50. The power source 18 may also power the infeed assembly 20 and the discharge assembly 80. The power source 18 operatively couples the feed system 30 and the material reducing system 50 to cause rotation of the feed wheels 32 and the cutting assembly. The power source 18 is typically operated such that the cutting assembly rotates at a relatively high velocity, while the feed wheels 32 rotate relatively slowly.

As is generally known, operation of waste processing machine 10 typically includes providing power to the material reducing system 50 and the feed system 30 through power supply 18, whereby feed system 30 feeds or supplies material to material reducing system 50. The material reducing system 50 reduces or otherwise processes the wood or other products, which are then discharged through the discharge assembly 80. The material reducing system 50 may comprise a rotary cutting mechanism, blade, or disc (not shown). The feed system 30 typically includes at leas one feed wheel 32. Both of these systems, the feed system 30 and the material reducing system 50) are described in great detail in the patents cited above and those descriptions are wholly incorporated herein by reference.

In operation, trees, brush, and other bulk wood products are fed into the infeed conveyor 22 and captured by the rotating feed wheel 32 of the feed system 30 which feeds, pulls, or otherwise causes the bulk wood products to encounter the material reducing system 50. The material reducing system 50 then reduces the bulk wood products, which are then expelled from the waste processing machine 10 through the discharge assembly 80 via the discharge conveyor 82.

It will be understood that prior art waste processing machines may comprise any suitable waste reducing machinery or system, such as the trailerable wood chipper as depicted in FIG. 1, or any other movable or stationary machinery used to chip, grind, cut, or otherwise reduce bulk products. While later described embodiments of the present disclosure incorporate a single feed wheel, it is also to be understood that any feed system can be incorporated into the present disclosure. Alternatively, a waste processing machine may include a feed system having no feed wheel, such as a gravity fed chute, without deviating from the scope of the present disclosure.

While the disclosed embodiments are depicted as having an internal combustion engine, a waste processing machine according to the present disclosure can be powered by any other suitable means including, but not limited to, electricity, gas, diesel, or a power take-off from an auxiliary power source without departing from the scope of this disclosure. It should be understood that this disclosure describes certain structures and operations with respect to a hydraulic system, however, other powering systems may also be utilized. Further, it is to be understood that numerous configurations of the individual components may be used and the description herein is not meant to be limiting with respect to these systems, unless otherwise noted, and equivalent components may be used.

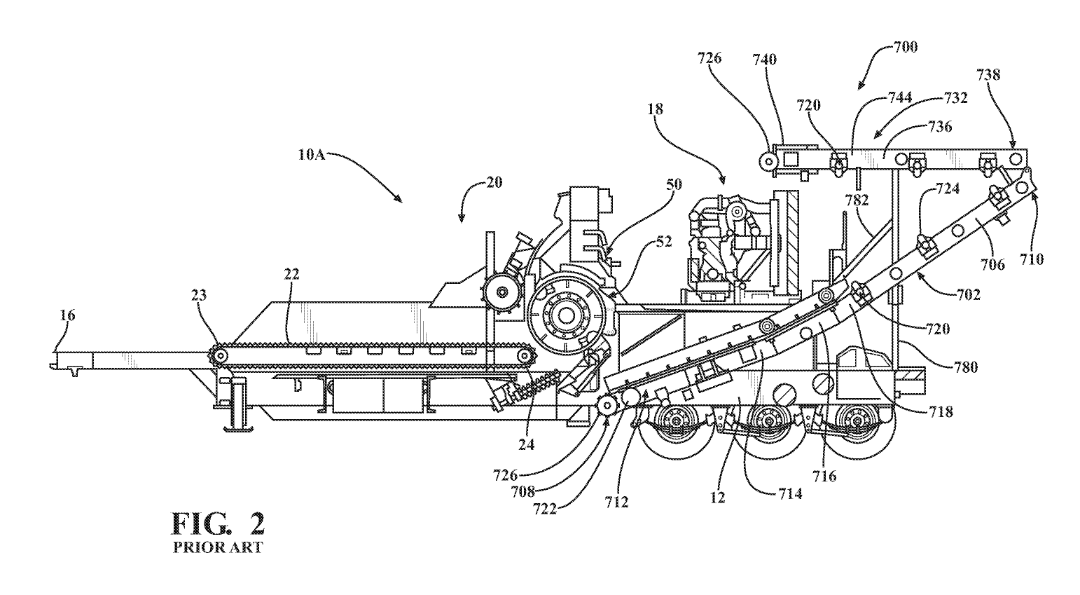

Referring now to FIG. 2, another prior art conveyor-fed waste processing machine 10A is illustrated. The waste processing machine 10A includes similar components and operation as the waste processing machine 10 depicted in FIG. 1, except that the waste processing machine 10A includes an articulated discharge system 700. The articulated discharge system 700 includes first and second discharge conveyor assemblies 702 and 732, respectively.

The first discharge conveyor assembly 702 includes a first discharge conveyor (not shown) operatively mounted to a first conveyor frame assembly 706 for operation to transport reduced material from a first end 708, which is disposed about (and in this embodiment adjacent to) the material reducing system 50, to a second end 710.

The first conveyor frame assembly 706 can be attached to frame 12 and can include one or more supporting frame members 712, 714, 716, and 718, along with one or more of conveyor belt pulleys 720, tension pulleys 722, and/or support pulleys 724. The first discharge conveyor assembly 702 is typically driven by one or more drive motors 726.

The second discharge conveyor assembly 732 includes a second discharge conveyor (not shown) operatively mounted to a second conveyor frame assembly 736 for operation and to transport reduced material from a first end 738, which is disposed about, and in this embodiment adjacent to the second end 710 of the first discharge conveyor assembly 702, to a second end 740 of the second discharge conveyor assembly 732.

The second conveyor frame assembly 736 can be attached to first conveyor frame assembly 706 and typically further comprises one or more supporting frame members 744, along with one or more of conveyor belt pulleys 720, tension pulleys 722 and/or support pulleys 724. The conveyor belt (not shown) is typically driven by one or more drive motors 726. The illustrated waste processing machine 10A includes a drive motor 726 at the first end 708 of the first conveyor frame assembly 706 and a second drive motor 726 at the second end 740 of the second discharge conveyor assembly 732. Supporting frame members 780 and 782 operatively mount and support first and second discharge conveyer assemblies 702 and 732, respectively, to frame 12.

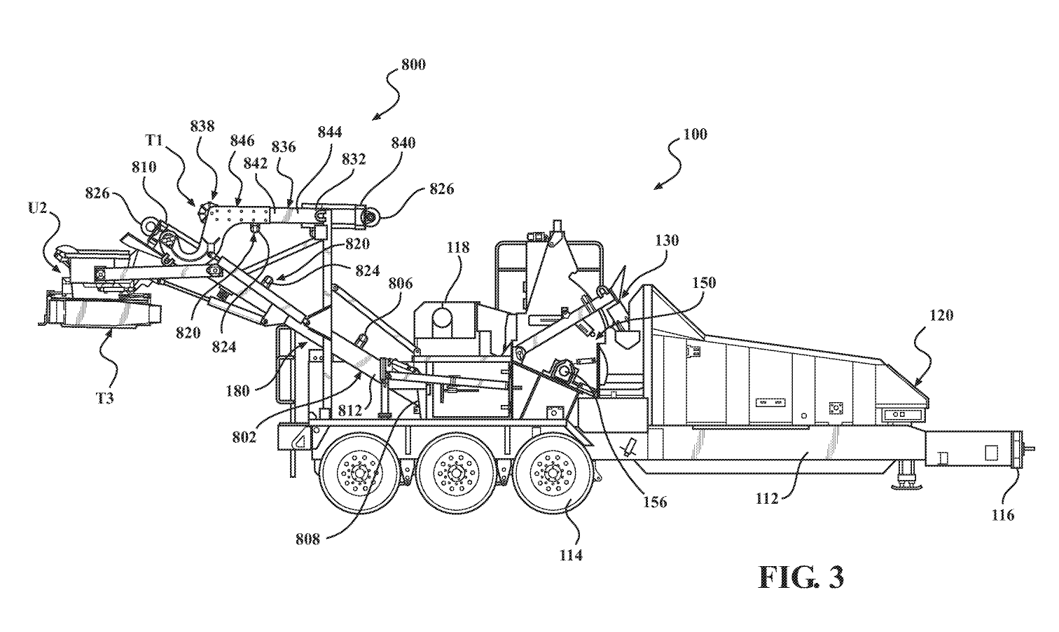

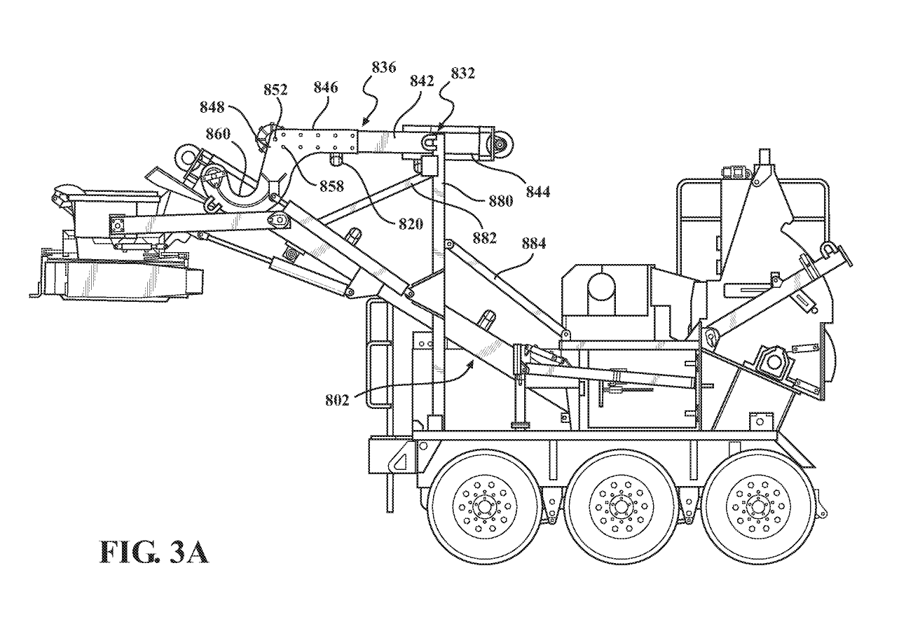

The disadvantages and drawbacks of the prior art machines are overcome through the waste processing systems of the present disclosure, wherein one embodiment is illustrated in FIG. 3. A waste processing system, shown generally at 100, includes a frame 112 supported by wheels 114, and a trailer hitch 116, allowing the waste processing system 100 to be transported by a vehicle. Supported on the frame 112 and together constituting component elements of the waste processing system 100, are an infeed assembly 120, a feed system 130, a material reducing system 150, and a discharge assembly 800.

The disadvantages and drawbacks of the prior art are overcome through the waste processing system 100 of the present disclosure, as illustrated in FIGS. 3 and 3A. Referring now to FIG. 3, the discharge assembly 800 includes a primary-stage discharge conveyor assembly 802 and a secondary-stage discharge conveyor assembly 832.

The primary-stage discharge conveyer assembly 802 includes a conveyor (not shown) operatively mounted to a first conveyor frame assembly 806 for operation and to transport reduced material from a first end 808, which is disposed about, and in this embodiment adjacent to, the material reducing system 150, to a second end 810, spaced from the material reducing system 150.

The first conveyor frame assembly 806 further includes one or more conveyor belt pulleys 820, tension pulleys (not shown), and/or support pulleys 824. The first conveyor frame assembly 806 is attached to frame 112 via one or more supporting frame members 812, for operatively mounting and supporting the primary-stage discharge conveyer assembly 802 to frame 112. The conveyor (not shown) of the primary-stage discharge conveyor assembly 802 is driven by one or more drive motors 826.

The secondary-stage discharge conveyor assembly 832 includes a conveyor (not shown) operatively mounted to a second conveyor frame assembly 836 for operation and to transport the reduced material from a first end 838, which is disposed about, and in this embodiment rotatably moveable to be adjacent to the second end 810 of the primary-stage discharge conveyor assembly 802, to a second end 840 of the secondary-stage discharge conveyor assembly 832.

The second conveyor frame assembly 836 is rotatably attached to first conveyor frame assembly 806 and includes one or more supporting frame members 842. The illustrated embodiment in FIGS. 3 and 3A includes the single supporting frame member 842 which is rotatably mounted to first frame assembly 806 via a rotatable frame support member 846 which is mounted to an end 848 of frame 844. The second conveyor frame assembly 836 further includes one or more conveyor belt pulleys 820, tension pulleys (not shown), and/or support pulleys 824. The conveyor of the secondary-stage discharge conveyor assembly is driven by one or more drive motors 826.

Also illustrated are supporting frame members 880, 882, and 884 for operatively mounting and supporting primary-stage and secondary-stage discharge conveyer assemblies, 802 and 832 respectively, to frame 112.

As best illustrated in FIGS. 4 and 4A-4C, the rotatable frame support member 846 rotatably mounts end 848 of frame 844 to first conveyor frame assembly 806, for rotation relative thereto. The rotatable frame support member 846 includes a mounting section 852 which is mounted adjacent to the first end 838 of the supporting frame member 844 via aligned through-holes in supporting frame member 844 and rotatable frame support member 846 via bolts 858.

The rotatable frame support member 846 further includes a U-shaped portion 860 comprising a pivot 862. An actuator 864, in this case a hydraulic arm, has a fixed end 868 mounted to a support bracket 870 affixed to the supporting frame member 880. The actuator 864 also has a positionable end 872 operatively connected to the U-shaped portion 860. In one embodiment, the positionable end 872 is connected to the U-shaped portion 860 via a bracket 874 which further comprises a pin 876 which rotates within bracket 874, whereby the actuator 864 rotationally moves the second conveyor frame assembly 836 about pivot 862 from a storage and transportation position T1 to an in-use position U1, and the full range there-between. The second conveyor frame assembly 836 is illustrated in the transportation position T1 in FIGS. 3 and 3A, and is illustrated in the in-use position U1 in FIGS. 4 and 4A-4C. The second conveyor frame assembly 836 resides on frame portion 886 when in storage position T1.

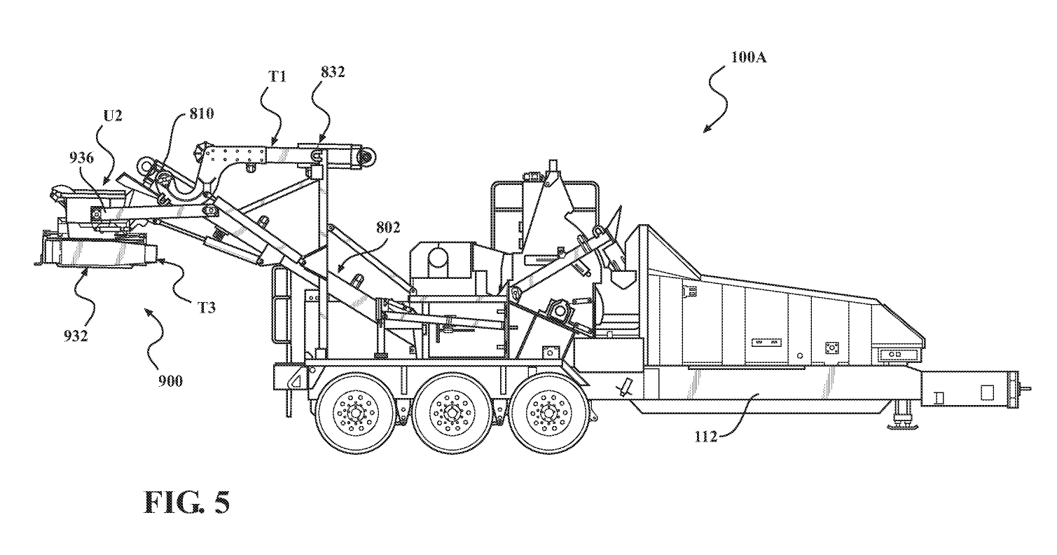

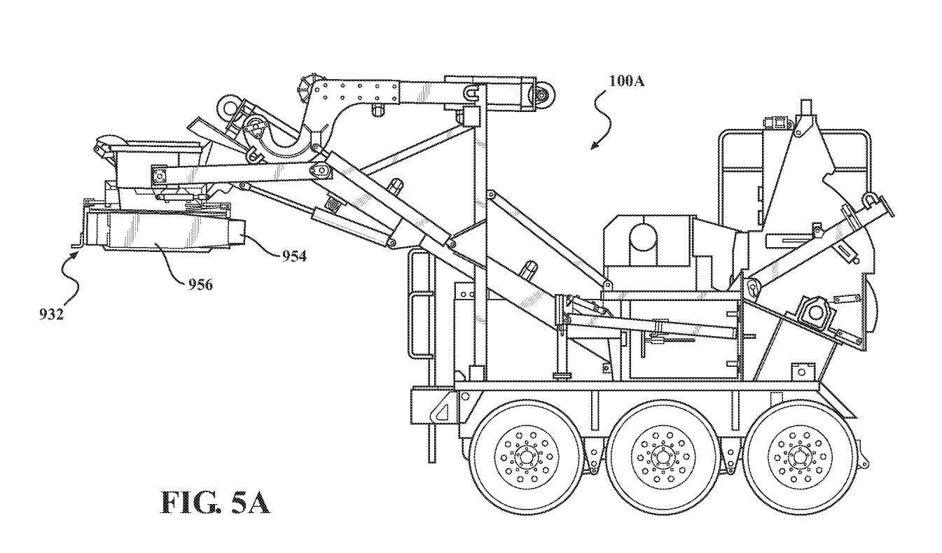

FIG. 5 illustrates another embodiment of the waste processing system 100A which includes a discharge assembly 900. In this embodiment, the discharge system 900 includes a primary-stage conveyor discharge conveyor assembly 802 and an independent secondary-stage discharge system 932 which may include, for example, a fan or horizontal “chip” thrower-type discharge system, including an impeller or fan. In the illustrated embodiment, the discharge system 900 takes the configuration whereby the primary-stage discharge conveyor assembly 802 supplies reduced material to the secondary-stage discharge system 932.

As previously discussed above, the primary-stage discharge conveyer assembly 802 includes a conveyor (not shown) operatively mounted to a first conveyor frame assembly 806 for operation to transport reduced material from a first end 808, which is disposed about (and in this embodiment adjacent to) material reducing system 150, to a second end 810. The first conveyor frame assembly 806 is attached to frame 112 via supporting frame members 880, 882, 884, and 886 to operatively mount and support the primary-stage discharge conveyer assembly 802 to frame 112.

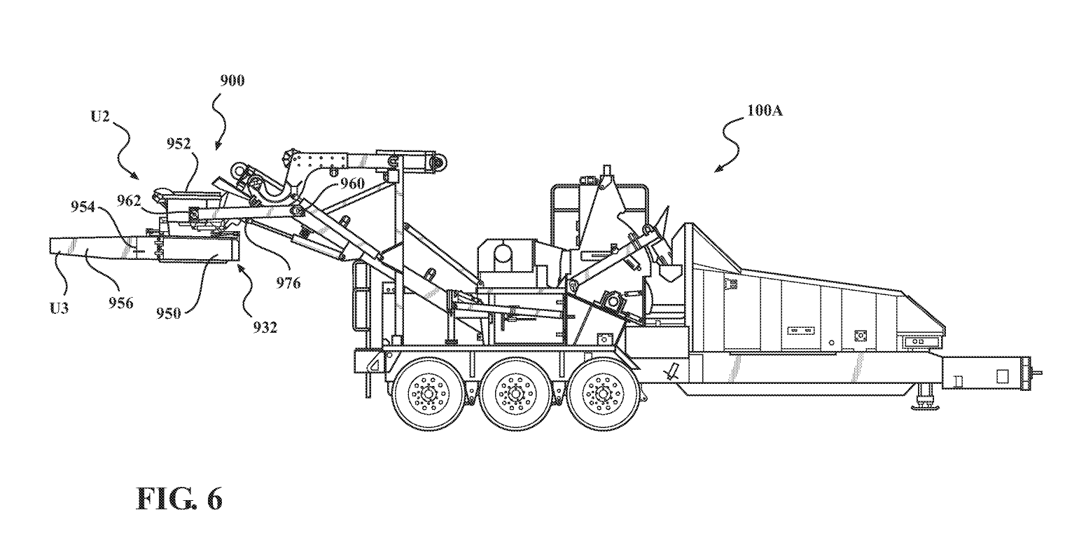

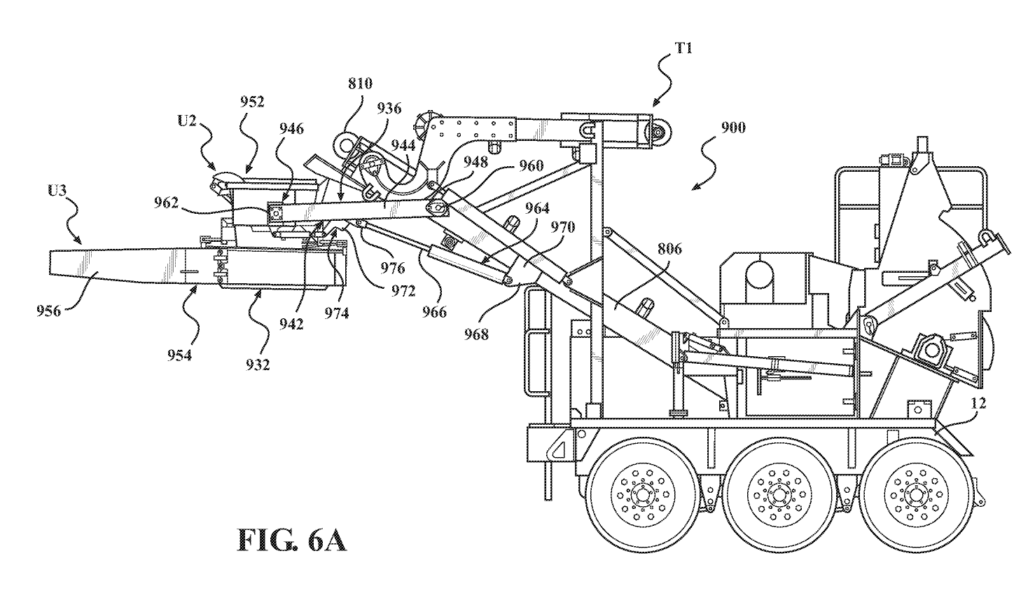

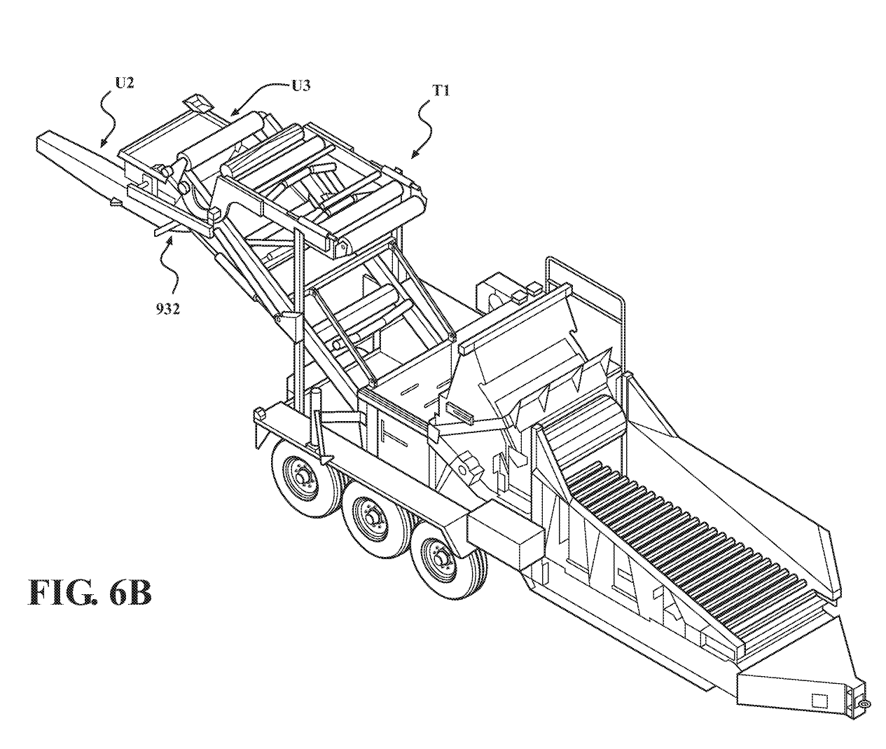

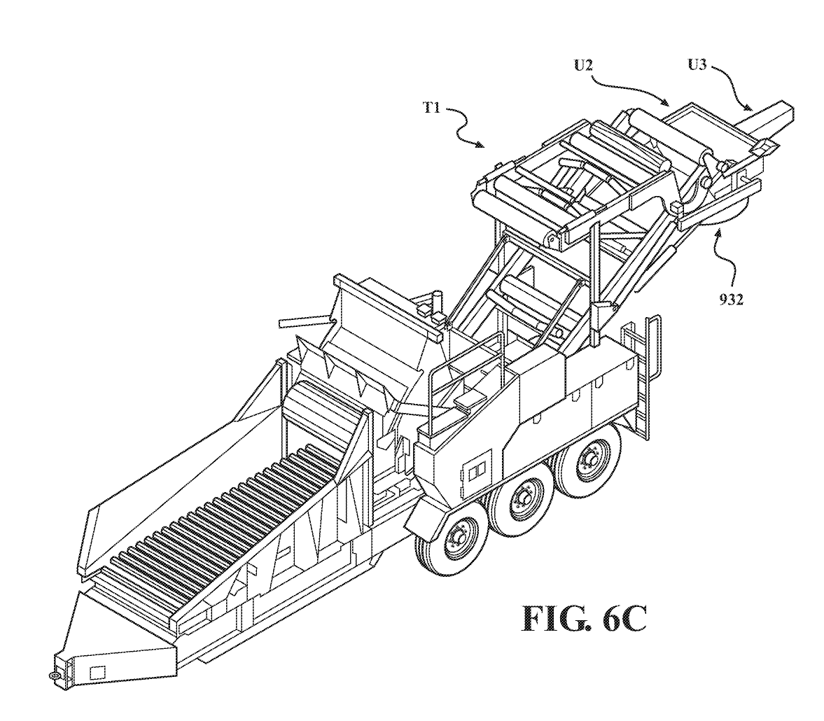

Referring now to FIG. 6, the secondary-stage discharge system 932 may include an accelerator, impeller, fan, centrifugal style discharge system, or other motion imparting system. For example, the impeller or fan (not shown) is operatively disposed in a housing 950 having an inlet 952 and an outlet 954. The housing 950 is operatively mounted to a third frame assembly 936 for operation, thereby expelling the reduced material from the waste processing system 100A. Such discharge systems may be more commonly known as a horizontal “chip” thrower or wood chip accelerator.

During operation, inlet 952 is disposed so as to receive the reduced material which is carried or otherwise conveyed by the primary-stage discharge conveyer assembly 802, and more specifically, via the second end 810 of the first conveyor frame assembly 806, whereby the impeller is adapted to be rotated in a selected direction to impart increased flow (i.e., imparts additional movement, higher velocity, more output) to the reduced material for discharge via the outlet 954 through discharge chute 956.

The discharge chute 956 is also operatively connected to the housing 950 so as to receive the reduced material and thereby allow the reduced material to be directed to a preferred location. Further, discharge chute 956 is rotatable about the housing 950 from a storage and transportation position T3 to an in-use position U3, and the full range therebetween.

The secondary-stage discharge system 932 is operably mounted to the frame 112 for use and for storage via third frame assembly 936, which is rotatably attached to first conveyor frame assembly 806 and further includes one or more supporting frame members. For example, this embodiment includes a supporting frame member 944 which is rotatably mounted to first conveyor frame assembly 806.

The third frame assembly 936 rotatably mounts the secondary-stage discharge system 932 to the frame 112. In one exemplary embodiment, an end 948 of third frame assembly 936 is pivotally connected to first conveyor frame assembly 806, for rotation relative thereto, via a first pivot 960. Housing 950 is pivotally connected to an opposite end 946 of supporting frame member 944 via a second pivot 962, thereby pivotally connecting the secondary-stage discharge system 932 to the first conveyor frame assembly 806.

Rotation of third frame assembly 936 is accomplished, in this embodiment, via an actuator 964, in this case a hydraulic arm, having a fixed end 968 mounted to a support bracket 970 affixed to frame 806, and a positionable end 972 operatively connected to the third frame assembly 936 via a linkage 974. In one embodiment, positionable end 972 is connected to the third frame assembly 936 via a bracket assembly which further comprises a pin 976 which rotates within the bracket assembly. Accordingly, the actuator 964 rotationally moves the third frame assembly 936 about pivot 960 from a storage or transportation position T2 to an in-use position U2, and the full range therebetween.

Alternatively, other motion imparting mechanisms may be used for secondary-stage discharge system 932 including, pumps and fans of any sort, including centrifugal pumps of any type, augers and other screw type systems. Thus, the secondary-stage discharge system 932 may include systems that impart motion by contacting the reduced material or exerting a force thereupon, for example, vacuum and pressure induced systems.

Structurally similar, the waste processing system 100 and waste processing system 100A illustrate the disclosed embodiment in alternative configurations where one or the other of the first, secondary-stage, discharge conveyor assembly 802 and the second, secondary-stage discharge system 932 is positioned to be employed in conjunction with the primary-stage discharge conveyor assembly 802. For simplicity, these may be referred to, respectively, as the primary-stage discharge system 802; first, secondary-stage discharge system 832; and second, secondary-stage discharge system 932. Accordingly, use of the waste processing system 100 is as follows. In a first mode of the waste processing system 100/100A, the first 832, and second 932, secondary-stage discharge systems are both in their respective storage and transportation positions T1, T2. In this first mode, the waste processing system 100 utilizes the primary-stage discharge system 802 to expel processed material. In a second mode of the waste processing system 100/100A, one or the other of the first 832, and second 932, secondary-stage discharge systems is in the respective in-use positions U1, U2. In this second mode, the waste processing system utilizes the primary-stage discharge system 802 in conjunction with the secondary-stage discharge system 832, 932 to expel processed material. As is clear from this description, to expel processed material simply means to convey the processed material away from the material reducing system 150 and the waste processing system 100, generally. Processed material may be expelled by conveyor, impeller, fan-assisted, or other discharge assembly or system, consistent with the above description.

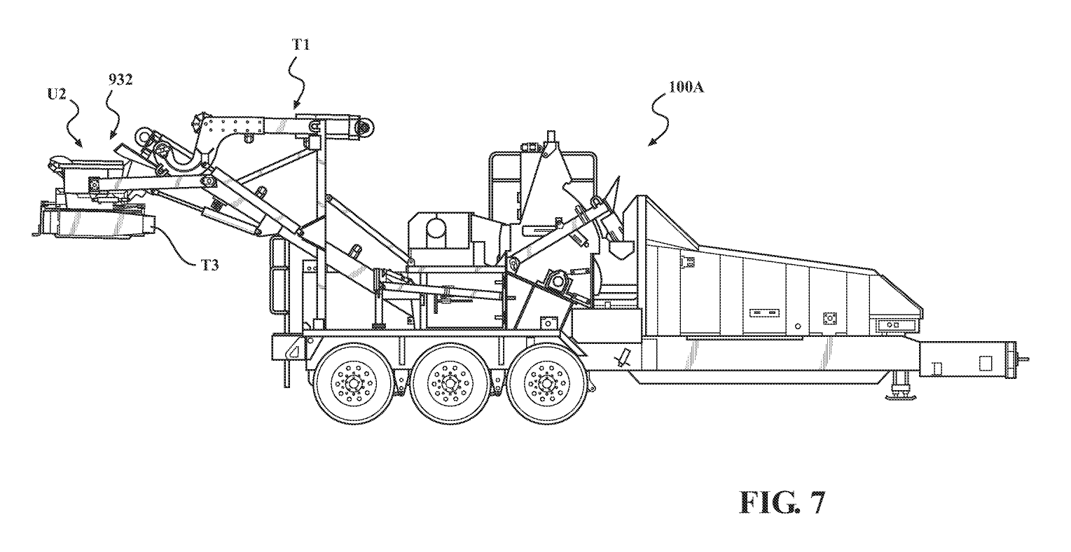

FIG. 7 illustrates the waste processing system 100/100A with the first, secondary-stage discharge system 832 in its storage and transportation configuration T1 and with the second, secondary-stage discharge system 932 in its in-use position U2. For utilization of the primary-stage discharge system 802 alone, the first, secondary-stage discharge system 832 and the second, secondary-stage discharge system 932 remain in their respective storage and transportation positions T1 and T2. The primary-stage discharge system 802, in this particular embodiment a conveyor, can then be operated normally.

However, if use of one or the other of the secondary-stage discharge systems 832 and 932 is desired, then each of the first and the second, secondary-stage systems may be utilized as described further hereinabove and below.

Accordingly, to utilize the first, secondary-stage discharge system 832, the second secondary-stage discharge system 932 is retained in its storage and transportation position T2, or moved from its in-use position U2 so as to be clear and unobstructive with respect to the primary-stage and first, secondary-stage discharge systems 802 and 832. The first secondary-stage discharge system 832 is rotated from its storage and transportation position T1 to its in-use position U1. Once in the in-use position U1, the first secondary discharge system 832 is ready to receive reduced material from the primary-stage discharge system 802 to thereby expel the waste material from the waste processing system 100/100A.

The movement of first secondary-stage and second secondary-stage discharge systems 832 and 932, respectively, is accomplished via actuators 864 and 964, respectively and, for example, via a control switch or lever (not shown). Such activations of actuators 864 and 964 may be accomplished either manually, via a switch, a lever, or automatically via a control system (not shown).

To utilize the second, secondary-stage discharge system 932, the second, secondary-stage discharge system 932 is moved from its storage and transportation position T2 to its in-use position U2. The first secondary-stage discharge system 832 may be maintained in or moved to its storage position T1.

Once the second, secondary-stage discharge system 932 is rotated to its in-use position U2, the discharge chute 956 is rotated from its storage and transportation position T3 into its corresponding in-use position U3. In one exemplary embodiment, discharge chute 956 is operatively connected to housing 950 via one or more hinges 996 and is manually moved from positions T3 and U3. Further, a spring latch assembly 994 may be used to retain and lock the discharge chute 956 into positions T3 and U3 whereby a spring loaded pin is received into a corresponding hole or slot (not shown). Once in position U2 and U3, the second secondary-stage discharge system 932 may receive reduced material from the primary-stage discharge system 802 via inlet 952 and thereby expel the waste material from reduced processing system 100.

In the illustrated exemplary embodiment, the first and second secondary-stage discharge systems 832 and 932 are hydraulically powered, and hydraulically movable via respective actuators 864 and 964. In alternative embodiments, other conventional articulating systems may be utilized.

Accordingly, it is possible to utilize the discharge system 800 as a stand-alone primary-stage conveyor style discharge system 802, or selectively, in combination with a secondary-stage discharge system which, in this illustrated embodiment, includes either the first secondary-stage conveyer-type discharge system 832, or the second, secondary-stage impeller-type discharge system 932. For example, the first secondary-stage discharge system 832 may be utilized to extend the reach of the primary-stage discharge system 802 without incurring additional discharge velocity. The second, secondary-stage discharge system 932 may be utilized to extend the reach of the primary-stage system 802 and also to increase the velocity of the expelled material. By way of further example, and with its comparatively low velocity discharge, the first secondary-stage discharge system 832 is well suited for loading over the top or the sides of a trailer, while the second, secondary-stage system 932, with its comparatively high velocity discharge, is well suited for loading from the back or rear of an enclosed trailer.

Also disclosed is a method of operating a waste processing system having a material reducing system, and a primary-stage discharge system, and a secondary-stage discharge system, the method including the steps of selecting one of the first and the second secondary-stage discharge systems for operation; moving the selected one of the first and the second secondary-stage discharge systems from its respective storage position to its respective in-use position; powering the selected one of the first and the second secondary-stage discharge systems in conjunction with the primary-stage discharge system; expelling waste material from the waste processing machine through the primary-stage discharge system and the selected one of the first and the second secondary-stage discharge systems; moving the selected one of the first and the second secondary-stage discharge systems from the in-use position back to its respective storage position.

The method may further include the step of moving the selected one of the first, and the second, secondary-stage discharge systems from the in-use position back to the respective storage position. Additionally, the method may also further include the steps of moving the other one of the first, and the second, secondary-stage discharge systems from the respective storage position to the respective in-use position; powering the other one of the first, and the second, secondary-stage discharge systems in conjunction with the primary-stage discharge system; and expelling material from the waste processing system through the primary-stage discharge system and the other one of the first, and second, secondary-stage discharge system.

Further disclosed is an alternative method of operating a waste processing system having a powered material reducing system, a primary-stage discharge system, and a secondary-stage discharge system, the method including the steps of selecting one of a first mode of operation wherein the waste processing system expels processed material via the primary-stage discharge system and a second mode of operation wherein the waste processing system expels processed material via the primary-stage discharge system in conjunction with the secondary-stage discharge system; selectively moving the secondary-stage discharge system from an in-use position to a storage position for operation in the first mode and moving the secondary-stage discharge system from the storage position to the in-use position for operation in the second mode; selectively powering the primary-stage discharge system for operation in the first mode and powering the primary-stage discharge system and the secondary-stage discharge system for operation in the second mode; and selectively expelling material from the waste processing system through the primary-stage discharge system for operation in the first mode and expelling material from the waste processing system through the primary-stage discharge system and the secondary-stage discharge system for operation in the second mode.

While a linear sequence of events has been described, it should be appreciated that various modifications can be made therein and, as such, the system does not necessarily require a linear sequence of events. It is also to be understood that various modifications may be made to the system, it sequences, methods, orientations, and the like without departing from the inventive concept. The description contained herein is merely an exemplary embodiment and hence, not meant to be limiting unless stated otherwise.

Advantageously, a novel waste processing system is disclosed, which provides for multiple discharge systems and configurations thereby increasing the discharge options which are available to the end-user and allowing for improved system operation and maximum flexibility and performance. The solutions disclosed herein have thus been attained in an economical and practical manner. Novel systems and methods for improving waste processing systems which are cost effective, easily configurable, and provide for increased operator and system efficiency and performance have been disclosed and described herein. While preferred embodiments and example configurations have been herein illustrated, shown, and described, it is to be appreciated that various changes, rearrangements, and modifications may be made therein, without departing from the scope of the disclosure. It is intended that the specific embodiments and configurations disclosed herein are illustrative of modes for practicing the invention, and should not be interpreted as limitations on the scope of the disclosure. It is to be appreciated that various changes, rearrangements, and modifications may be made therein, without departing from the scope of the disclosure.

1. A waste processing system (100) for reducing material, the waste processing system (100) comprising:
a frame (112) comprising at least one pair of wheels (114);
a material reducing system (150) operatively supported on the frame (112);
a primary-stage discharge system (802) disposed adjacent the material reducing system (150) to expel processed material when the system is in a first mode; and
a secondary-stage discharge system (832, 932) disposed adjacent the primary-stage discharge system (802) to expel processed material when the system is in a second mode;
wherein the primary-stage discharge system (802) operates independently from the secondary-stage discharge system (832, 932) when the waste processing system (100) is in the first mode, and wherein the secondary-stage discharge system (832, 932) operates cooperatively with the primary-stage discharge system (802) when the waste processing system (100) is in the second mode.

2. The waste processing system (100) of claim 1, wherein the secondary-stage discharge system (832, 932) comprises a first (832), and a second (932), secondary-stage discharge system, wherein the first (832), and the second (932), secondary-stage discharge systems are independently operable.

3. The waste processing system (100) of claim 1, wherein the primary-stage discharge system (802) comprises a conveyor.

4. The waste processing system (100) of claim 2, wherein the first, secondary-stage discharge system (832) comprises a conveyor.

5. The waste processing system (100) of claim 2, wherein the second, secondary-stage discharge system (932) is a fan-assisted discharge.

6. The waste processing system (100) as set forth in claim 2, wherein the first, secondary-stage discharge system (832) is a conveyor system and the second, secondary-stage discharge system (932) is an impeller discharge system.

7. The waste processing system (100) of claim 1, further comprising an infeed assembly (120) supported on the frame (112) for receiving material to be reduced; and a feed system (130) supported on the frame (112) and disposed between the infeed assembly (120) and the material reducing system (150) for conveying material from the infeed assembly (120) to the material reducing system (150).

8. The waste processing system (100) of claim 1, further comprising a primary power source (118) operatively supported by the frame (112), the material reducing system (150) powered by the primary power source (118).

9. The waste processing system (100) of claim 2, wherein the first (832), and second (932), secondary-stage discharge systems are, respectively, rotatably supported on the frame (112).

10. The waste processing system (100) of claim 9, wherein the first (832), and second (932), secondary-stage discharge systems are, respectively, rotatably positionable between a storage and transportation position (T1, T2) and an in-use position (U1, U2).

11. The waste processing system (100) of claim 10, wherein the respective in-use positions (U1, U2) of the first (832), and second (932), secondary-stage discharge systems dispose the respective first (832), and second (932), secondary-stage discharge systems adjacent to the primary-stage discharge system (802) for cooperative operation therewith.

12. The waste processing system (100) of claim 10, wherein the respective storage and transportation position (T1, T2) of the first (832), and second (932), secondary-stage discharge systems dispose the respective first (832), and second (932), secondary-stage discharge systems remote from the primary-stage discharge system (802).

13. The waste processing system (100) of claim 9, wherein the first (832), and second (932), secondary-stage discharge systems further comprise respective hydraulic actuators (864, 964) for powered rotation between respective storage and transportation positions (T1, T2) and respective in-use positions (U1, U2).

14. The waste processing system (100) of claim 13, further comprising a primary power source (118) operatively supported by the frame (112), the primary-stage (802) and secondary-stage (832, 932) discharge systems powered by the primary power source (118).

15. The waste processing system (100) of claim 14, wherein the primary power source (118) powers the respective hydraulic actuators (864, 964) of the first (832), and second (932), secondary-stage discharge systems.

16. The waste processing system (100) of claim 14, wherein the primary power source (118) selectively powers the respective operation of the first (832), and second (932), secondary-stage discharge systems in the in-use position (U1, U2) and not in the storage and transportation position (T1, T2).

17. A method of operating a waste processing system (100) having a material reducing system (150), a primary-stage discharge system (802), and first (832) and second (932) secondary-stage discharge systems, the method comprising the steps of:
selecting one of the first (832), and the second (932) secondary-stage discharge systems for operation;
moving the selected one of the first (832), and the second (932), secondary-stage discharge systems from a respective storage position (T1, T2) to a respective in-use position (U1, U2);
powering the selected one of the first (832), and the second (932), secondary-stage discharge systems in conjunction with the primary-stage discharge system (802); and
expelling material from the waste processing system (100) through the primary-stage discharge system (802) and the selected one of the first (832), and second (932), secondary discharge systems.

18. The method of claim 17, further comprising the step of moving the selected one of the first (832), and the second (932), secondary-stage discharge systems from the in-use position (U1, U2) back to the respective storage position (T1, T2).

19. The method of claim 18, further comprising the steps of moving the other one of the first (832), and the second (932), secondary-stage discharge systems from the respective storage position (T1, T2) to the respective in-use position (U1, U2);
powering the other one of the first (832), and the second (932), secondary-stage discharge systems in conjunction with the primary-stage discharge system (802); and
expelling material from the waste processing system (100) through the primary-stage discharge system (802) and the other one of the first (832), and second (932), secondary-stage discharge system.

20. A method of operating a waste processing system (100) having a material reducing system (150), a primary-stage discharge system (802), and a secondary-stage discharge system (832, 932), the method comprising the steps of:
selecting between one of a first mode of operation wherein the waste processing system (100) expels processed material via the primary-stage discharge system (802) independently, and a second mode of operation wherein the waste processing system (100) expels processed material via the primary-stage discharge system (802) in conjunction with the secondary-stage discharge system (832, 932);
selectively moving the secondary-stage discharge system (832, 932) from an in-use position (U1, U2) to a storage position (T1, T2) for operation in the first mode, and moving the secondary-stage discharge system (832, 932) from the storage position (T1, T2) to the in-use position (U1, U2) for operation in the second mode;
selectively powering the primary-stage discharge system (802) independently for operation in the first mode and powering both of the primary-stage discharge system (802) and the secondary-stage discharge system (832, 932) for operation in the second mode; and
selectively expelling material from the waste processing system (100) through the primary-stage discharge system (802) independently for operation in the first mode and expelling material from the waste processing system (100) through the primary-stage discharge system (802) and the secondary-stage discharge system (832, 932) cooperatively for operation in the second mode.
